(19) United States
(12) Patent Application Publication
(10) Pub. No.: US 2011/0101919 A1
(43) Pub. Date: May 5, 2011

(54) LITHIUM ION BATTERY PACK

(75) Inventors: Richard C. Polk, Henderson, NV (US); Eric Villarreal, Las Vegas, NV (US); Tim A. Sunderlin, Henderson, NV (US); Kye W. Stoker, Henderson, NV (US); John Nguyen, Henderson, NV (US)

(73) Assignee: K2 ENERGY SOLUTIONS, INC., HENDERSON, NV (US)

(21) Appl. No.: 12/915,887

(22) Filed: Oct. 29, 2010

Related U.S. Application Data
(60) Provisional application No. 61/256,094, filed on Oct. 29, 2009.

(51) Int. Cl. H02J 7/04

(52) U.S. Cl. 320/118

(57) ABSTRACT

A lithium iron phosphate battery pack is disclosed. The battery pack includes a plurality of battery cells, arranged as groups of cells, a controller circuit, and a plurality of intercell tabs coupling the groups of battery cells to the controller circuit. The controller circuit includes a voltage sensor for monitoring the voltage across each of the groups of cells. If one of the groups has a voltage that is lower or higher than a respective lower or upper threshold voltage, the controller circuit will shut off the charge/discharge cycling of all the groups of cells. In doing so, the controller circuit protects the entire battery pack during charge/discharge cycling.

### CROSS-REFERENCE TO RELATED APPLICATION

This application claims the benefit of U.S. Provisional Application Ser. No. 61/256,094, filed on Oct. 29, 2009, the entirety of which is incorporated herein by reference.

### TECHNICAL FIELD

This patent relates to high energy density batteries, and more particularly to a lithium ion battery pack, such as a lithium iron phosphate (LiFePO₄) battery pack for use in a personal mobility vehicle, such as a wheelchair, and in a wheelchair lift.

### BACKGROUND OF THE INVENTION

Battery powered devices, such a battery powered personal mobility vehicles, such as battery powered wheel chair, or battery powered personal mobility vehicle lifts, have traditionally been powered by a conventional, rechargeable, lead acid battery packs, such as 12 v or 24 v. Developments in lithium ion battery cell technology have resulted in battery packs containing lithium ion battery cells replacing lead acid batteries in certain applications. In order to achieve the necessary output voltage and capacity, such lithium ion battery packs often comprise a plurality of groups of lithium ion battery cells connected in series, wherein each of the groups of battery cells comprises a plurality battery cells connected in parallel.

One problem that may occur involves over-charging of lithium ion battery cells. When charging series connected lithium ion battery cells, the cells do not necessarily charge at the same rate. Thus one of the groups of battery cells may begin to exceed its nominal voltage before the other groups of battery cells reach their nominal voltage(s). As battery chargers typically do not stop charging the series connected cells until the cumulative series voltage of the cells reaches a threshold voltage, the group of cells which first reaches its nominal voltage may end up being over-charged, which can damage the particular battery cells of that group.

There can also be a problem if the battery charger is connected to one or more battery cells, or groups of battery cells, in reverse polarity.

### BRIEF DESCRIPTION OF THE DRAWINGS

For a more complete understanding of the disclosure, reference should be made to the following detailed description and accompanying drawings wherein:

FIG. 1 is a perspective view of a first embodiment of a battery pack, such as for use in a wheelchair lift, according to one embodiment of the invention;

FIG. 2 is an exploded view of the battery pack of FIG. 1;

FIG. 3 is a perspective view of a second embodiment of a battery pack, such as for use in an electric wheelchair, according to the invention; and

FIG. 4 is an exploded view of the battery pack of FIG. 3.

### DETAILED DESCRIPTION OF THE INVENTION

While the invention of the present disclosure is susceptible to various modifications and alternative forms, embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claim.

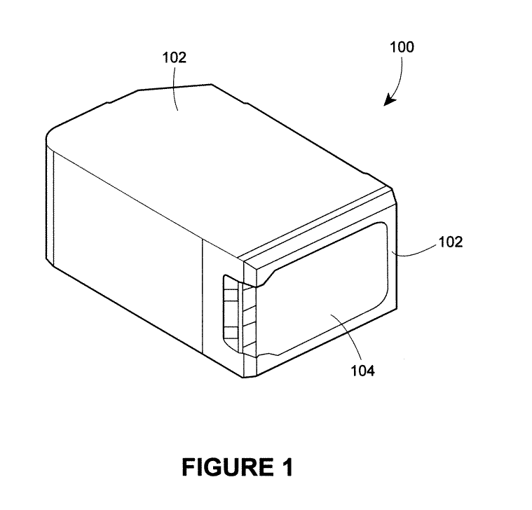

A first embodiment of a battery pack 100 according to the present invention is illustrated in FIG. 1. The battery pack 100 may be a lithium ion battery pack, such as a LiFePO₄ battery pack, suitable for inclusion in a lift assembly such as a wheelchair lift, a wheelchair carrier, and the like. The battery pack 100 has high energy density, fast recharge time, long cycle life, a flat discharge profile, and is considered to be environmentally friendly.

The battery pack 100 may have a height of about 67.2 mm, a width of about 96.0 mm, and a length of about 155.0 mm, though other dimensions are also contemplated. The battery pack 100 includes an enclosure 102 with an opening 104 formed at one end of the enclosure 102. The enclosure 102 may be a shrink-wrap type film or an injection-molded or extruded hard plastic case. The battery pack 100 has a nominal 12 v output and may replace a conventional 12 v lead-acid battery, which tends to have a shorter life span and a lower energy capacity.

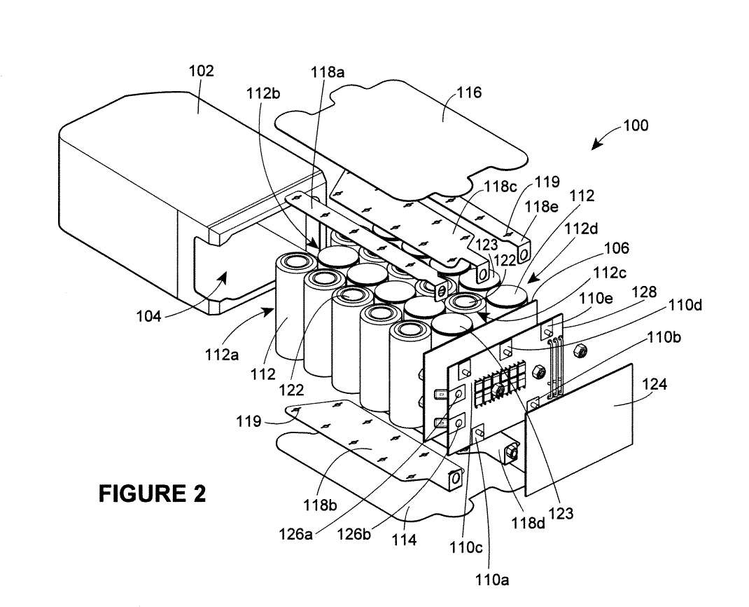

The battery pack 100 is shown in detail in FIG. 2. The battery pack 100 includes twenty battery cells 112 arranged as four groups 112a-112d of five of the battery cells 112. Each of the cells 112 may be for example, a high energy rechargeable LiFePO₄ cell with a nominal output of 3.2 volts and 3200 mAh, as sold by K2 Energy Solutions, Inc, of Henderson, Nev. The cells 112 are formed in a cylindrical shape and include a positive terminal 122 and a negative terminal 123. It will be understood that other shapes or configurations may be used depending on the application in which the battery pack 100 will be used. The positive terminals 122 of the first and third rows 112a, 112c face one direction, and the positive terminals 123 of the second and fourth rows 112b, 112d face in an opposite direction.

The battery pack 100 further includes five intercell tabs 118a-118e. Each of the intercell tabs 118a-118e includes a plurality of through holes 119, corresponding to the number of cells 112 used in the battery pack 100. The holes 119 are also aligned with and mated with the positive terminals 122 and the negative terminals 123 of the cells 112. The intercell tabs 118a-118e are welded, such as by resistance welding, to respective ones of the cells 112.

The first intercell tab 118a is connected to only positive terminals 122 of the first group 112a of the battery cells 112 and is referred to as the positive intercell tab. Similarly the fifth intercell tab 118e is connected to only the negative terminals 123 of the fourth group 112d of the battery cells 112 and is referred to as the negative intercell tab. The second, third and fourth intercell tabs 118b-118d interconnect the first through fourth groups 112a-112d of battery cells, respectively. The second, third and fourth intercell tabs 118b, 118c and 118d are known as offset configuration intercell tabs because of the positive and negative terminals arrangement as described above.

The battery pack 100 further includes two sheets of fish paper 114, 116 (reinforced insulating papers). The fish papers 114, 116 prevent accidental shorting of the cells 112 to the enclosure 102. Once all the intercell tabs 118a-118e are connected to the cells 112, the first fish paper 114 is placed on the outer surface of the intercell tabs 118a, 118b, and the second fish paper 116 is placed on the outer surface of the intercell tabs 118c-118d. The battery pack 100 further includes two insulating papers 106, 124 and a controller circuit 128 mounted on a circuit board and sandwiched between the insulating papers 106, 124.

As illustrated in FIG. 2, the insulating papers 106, 124 and the controller circuit 128 are placed at one end of the cells 112 adjacent to the opening 104. The controller circuit 128 includes a conventional voltage sensor and a number of metal-oxide-semiconductor field-effect transistors (MOSFETs) and a plurality of terminal pads 110a-110e. The positive intercell tab 118a is connected to the terminal pad 110c, and the negative intercell tab 118e is connected to the terminal pad 110e. Finally, the offset configuration intercell tabs 118b, 118c, 118d, respectively, are connected to the terminal pads 110a, 110b, 110d. The remaining terminal pads 126a, 126b are connected to external components (not shown).

The cells groups 112a-112d of the cells 112 may charge and discharge at different cycle rates, resulting in a varying voltage across each of the groups 112a-112d of the cells 112. In order to protect the entire battery pack 100 during the charge/discharge cycling, the voltage sensor senses the voltage across each of the groups of the cells. If one of the groups 112a-112d has a voltage that is lower or higher than a lower or upper threshold voltage, such as 2.5 v or 3.65 v, respectively, the controller circuit 128 will shut off the charge/discharge cycling of all the cells 112.

Alternatively more advanced controller circuits may be utilized. One such controller circuit could, when the sensed voltage across one of the groups of battery cells exceeds a threshold voltage during a charging cycle, shunt charging current around that particular group of battery cells, while continuing to charge the other groups of battery cells. This could be continued until all of the groups of battery cells have been properly charged.

Another such controller circuit could prevent charging current from flowing through a group of battery cells which have been installed in reverse-polarity.

Such alternative circuits are disclosed in co-pending U.S. patent application Ser. Nos. 12/871,415 and 12/871,471, each filed on Aug. 30, 2010 and assigned to the assignee of this application, the disclosures of which are expressly incorporated herein.

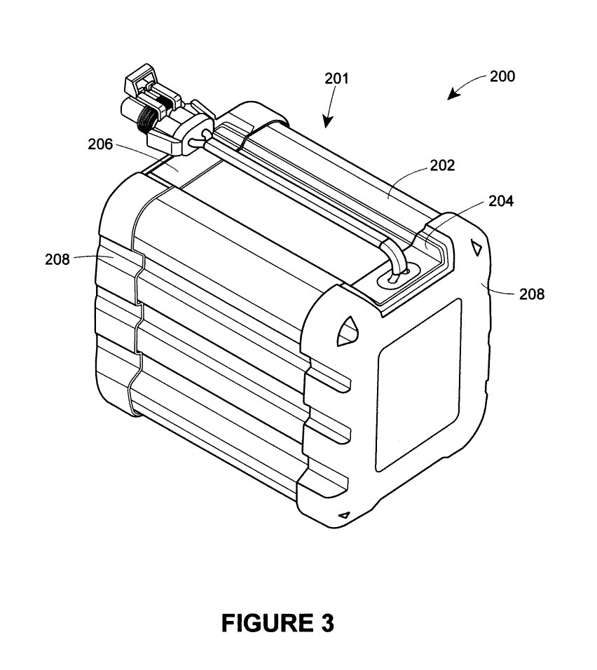

A second embodiment of a battery pack 200 according to the present invention is illustrated in FIG. 3. The battery pack 200 may be a LiFePO₄ battery pack suitable for inclusion in a personal mobility vehicle such as a powered wheelchair or scooter, and the like. The battery pack 200 has high energy density, fast recharge times, long cycle life, a flat discharge profile, and is considered to be relatively environmentally friendly. The battery pack 200 has a nominal 12v output and is provided to replace a conventional 12v lead-acid battery, which tends to have a shorter life span and a lower energy capacity.

The battery pack 200 may have a height of about 116.0 mm, a width of about 133.2 mm, and a length of about 167.0 mm, though other dimensions are also contemplated. The battery pack 200 includes an enclosure 201 with a hollow casing 202, a front cap 204, a rear cap 206, and two rubber end moldings 208. The front cap 204 is attached to the front end of the hollow casing 202, and the rear cap 206 is attached to the rear end of the hollow casing 202. The rubber end moldings 208 then wrap around the front and rear caps 204, 206.

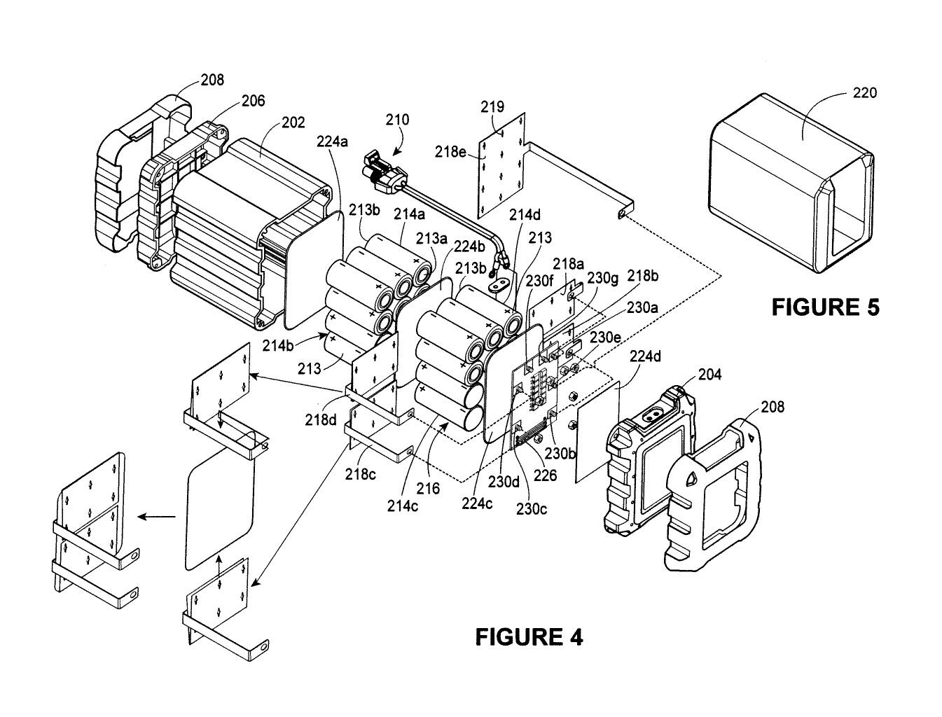

Referring to FIG. 4, the battery pack 200 includes four groups 214a-214d of battery cells 213. The groups 214a-214d of the cells are arranged in series. Each of the groups 214a-214d includes six of the cells 213 arranged in parallel. Each of the cells 213 may be for example, a high energy rechargeable LiFePO₄ cell with a nominal 3.2 volt, 3200 mAh output, as sold by K2 Energy Solutions, Inc, of Henderson, Nev. The cells 213 are formed in a cylindrical shape and include a positive terminal 213a and a negative terminal 213b. It will be understood that other shapes or configurations may be used depending on the application in which the battery pack 200 will be used.

The battery pack 200 further includes five intercell tabs 218a-218e. Each of the intercell tabs 218a-218e includes a plurality of through holes 219, corresponding to the number of cells 213 used in the battery pack 200. The holes 219 are also aligned with and mated with the positive terminals 213a and the negative terminals 213b of the cells 213.

As illustrated in FIG. 4, the intercell tabs 218a-218e electrically couple the groups 214a-214d of the cells 213 in series, as well as collectively electrically couple the series of groups to a controller circuit 226 on a circuit board.

The battery pack 200 further includes four sheets of insulating papers 224a-224d. The first sheet of the insulting paper 224a is provided at the outer surface of the intercell tab 218e to prevent accidental shorting of the cells 213 to the enclosure 201. The second sheet of the insulating paper 224b is overlapped by the intercell tabs 218c, 218d to insulate the first and second groups 214a, 214b of the cells 213 from the third and fourth groups 214c, 214d of the cells 213. The third sheet of the insulating paper 224c is provided to insulate third and fourth groups 214c, 214d of the cells 213 from the controller circuit 226. The fourth sheet of the insulating paper 224d is provided to insulate the controller circuit 226 from the enclosure 201.

The battery pack 200 further includes a shrink-wrap type film 220 to hold the various components in place before these components are placed in the enclosure 201.

The controller circuit 226 includes a conventional voltage sensor and a number of metal-oxide-semiconductor field-effect transistors (MOSFETs) and a plurality of terminal pads 230a-230g. As illustrated in FIG. 4, the intercell tab 218a is connected to the terminal pad 230a, and the intercell tab 218b is connected to the terminal pad 230b. The intercell tab 218e is resistance welded to the first group of cells 214 connected to the terminal pad 230e provided between the terminal pads 230a, 230b. The intercell tabs 218c, 218d are resistance welded to the first and second groups of cells 214, 216 and are connected to the terminal pads 230c, 230d, respectively. The terminal pads 230f, 230g are connected to wire assembly 210, which in turn connects to an external component (not shown).

As with the battery pack of the first embodiment, if one of the groups 214a-214d of the cells 213 has a voltage that is lower or higher than a lower or upper threshold voltage, such as 2.5 v or 3.65 v, respectively, the controller circuit 226 will shut off the charge/discharge cycling of all the groups of the cells.

The alternative controller circuits described above with respect to the first embodiment of the battery pack 100 could also be incorporated in the second embodiment of the battery pack 200.

Other embodiments, such as other quantities of battery cells comprising a battery cell group, or other total quantities of battery cells groups, to achieve other output voltages, capacities and dimensions are contemplated.

Preferred embodiments of this invention are described herein. It should be understood that the illustrated embodiments are exemplary only, and should not be taken as limiting the scope of the invention.

1. A battery pack comprising:
a housing;
a plurality of lithium ion battery cell groups, each of the battery cell groups comprising a plurality of battery cells configured in parallel, wherein the plurality of battery cell groups are disposed in the housing;
a plurality of current conducting intercell tabs interconnecting the battery cell groups in series;
a controller having a voltage sensor, wherein the intercell tabs are coupled to the controller such that the voltage sensor can sense the voltage across each individual battery cell group and wherein the controller, in response to the sensed voltage across each individual battery cell group indicating that the voltage across one of the battery cell groups is higher or lower than a respective upper or lower threshold voltage, affects respective charging or discharging of the battery pack.

2. The battery pack of claim 1 wherein the controller, in response to the sensed voltage across each individual battery cell group indicating that the voltage across one of the battery cell groups exceeds is higher or lower than the respective upper or lower threshold voltage, terminates the respective charging or discharging of all of the battery cell groups.

3. The battery pack of claim 1 wherein the controller, in response to the sensed voltage across each individual battery cell group indicating that the voltage across one of the battery cell groups exceeds the upper threshold voltage, terminates charging of the particular battery cell group, while permitting charging of the remaining battery cell groups.

4. A battery pack comprising:
a housing;
a plurality of lithium ion battery cell groups interconnected, each of the battery cell groups comprising a plurality of battery cells configured in parallel, wherein the plurality of battery cell groups are disposed in the housing;
a plurality of current conducting intercell tabs interconnecting the battery cell groups in series;
a controller having a voltage sensor, wherein the intercell tabs are coupled to the controller such that the voltage sensor can sense the voltage across each individual battery cell groups and wherein the controller, in response to the sensed voltage across each individual battery cell group indicating that the voltage across one of the battery cell groups is higher or lower than a respective upper or lower threshold voltage, terminates the respective charging or discharging of all of the battery cell groups.

5. The battery pack of claim 1 consisting of four battery cell groups, each of the battery cell groups consisting of five battery cells.

6. The battery pack of claim 1 consisting of four battery cell groups, each of the battery cell groups consisting of six battery cells.

7. For a battery pack comprising a housing and a plurality of lithium ion battery cell groups, each of the battery cell groups comprising a plurality of battery cells configured in parallel, a method for preventing overcharging of the battery cell groups, the method comprising:
providing a plurality of current conducting intercell tabs interconnecting the battery cell groups in series;
providing a controller having a voltage sensor;
coupling the intercell tabs to the controller such that the voltage sensor can sense the voltage across each individual battery cell group;
sensing the voltage across each battery cell group;
affecting the charging or discharging of a battery cell group in response to the sensed voltages indicating that the voltage across one of the battery cell groups is respectively higher or lower than a respective upper or lower threshold voltage.

8. The method of claim 7 wherein the respective charging or discharging of the battery cell group is affected by terminating the respective charging or discharging of all of the battery cell groups.

9. The method of claim 7 wherein the charging of the battery cell group is affected when the sensed voltage exceeds the upper threshold voltage by terminating the charging of the particular battery cell group but permitting charging of the remaining battery cell groups.
